(19) United States
(12) Patent Application Publication
(10) Pub. No.: US 2004/0027289 A1
(43) Pub. Date: Feb. 12, 2004

(54) Type circuit board antenna

(75) Inventor: Jackson Huang, Hsinchu (TW)

Correspondence Address: SQUIRE, SANDERS & DEMPSEY L.L.P, 600 HANSEN WAY, PALO ALTO, CA, 94304-1043, US

(73) Assignee: Z-Com, Inc., Hsinchu (TW)

(21) Appl. No.: 10/412,184

(22) Filed: Apr. 11, 2003

(30) Foreign Application Priority Data
Aug. 6, 2002 (TW) 091212115

(51) Int. Cl. H01Q 1/38

(52) U.S. Cl. 343/700 MS

(57) ABSTRACT

A new type circuit board antenna is proposed. There is a circuit board having a surface. A first strip conducting part locates at the surface of the circuit board. A first U-type conducting part locates at the surface of the circuit board and connects with the first strip conducting part. A second U-type conducting part locates at the surface of the circuit board and is complementary with the first U-type conducting part. A grounding part locates at the surface of the circuit board and connects with the first strip conducting part. A second strip conducting part connects with the second U-type conducting part and combines the ground part as a micro strip for conducting the antenna signal.

### FIELD OF THE INVENTION

The present invention is relative to a new type circuit board antenna, and more particularly to the new type circuit board antenna for the wireless local area network (LAN) communication.

### BACKGROUND OF THE INVENTION

Wireless communication applications are very popular in our daily life, such as the wireless mobile phone, the wireless modem, the wireless network card, etc. The wireless communication is based on the radio frequency (RF) transmission technology to communicate with two users in real time, and the antenna is a very important component in the design of the signal transmission.

FIG. 1 (A) and FIG. 1 (B) show the front and back diagrams of the traditional wireless LAN antenna. There are two strip conducting parts 121, 122 and one grounding part 13 at the front of the circuit board 111. And there are two strip conducting parts 141, 142 at the back of the circuit board 112. The strip conducting parts 121 and 141 are opposite, and the strip conducting parts 122 and 142 are opposite, too. That is, the conducting via hole 15 of the strip conducting part 141 intercommunicates with the conducting via hole 15 of the strip conducting part 121, and the conducting via hole 15 of the strip conducting part 142 intercommunicates with the conducting via hole 15 of the strip conducting part 122.

The structure of the traditional wireless LAN circuit board antenna is very simple, but the signal receiving quality is not very good. If we can design a new antenna with better efficiency, then we may improve the data transmission efficiency of the wireless network.

### SUMMARY OF THE INVENTION

The objective of the present invention is to design a new antenna to improve the data transmission efficiency of the wireless network by using the micro strip and r (Gama) matching theories.

### BRIEF DESCRIPTION OF THE INVENTION

According to the present invention, a new type circuit board antenna comprises:

One circuit board having a surface;

One first strip conducting part locating at the surface of the circuit board;

One first U-type conducting part locating at the surface of the circuit board and connecting with the first strip conducting part;

One second U-type conducting part locating at the surface of the circuit board and being complementary with the first U-type conducting part;

One grounding part locating at the surface of the circuit board and connecting with the first strip conducting part; and

One second strip conducting part locating at the surface of the circuit board and connecting with the second U-type conducting part, and combining with the grounding part as a micro strip for conducting the antenna signal.

In accordance with one aspect of the present invention, the back side of the circuit board surface comprises a third strip conducting part, and the third strip conducting part is parallel with the first strip conducting part, and intercommunicates by a plurality of conducting via holes.

In accordance with one aspect of the present invention, the back side of the circuit board surface comprises another grounding part, and these two grounding parts intercommunicate by a plurality of conducting via holes.

In accordance with one aspect of the present invention, the first U-type conducting part and the second U-type conducting part are integrated as a r(Gama) matching.

In accordance with one aspect of the present invention, this new antenna can be used in a wireless LAN card.

The present invention may best be understood through the following description with reference to the accompanying drawings, in which:

### BRIEF DESCRIPTION OF THE DRAWINGS

FIGS. 1 (A) (B): The front and back diagrams of the traditional circuit board antenna.

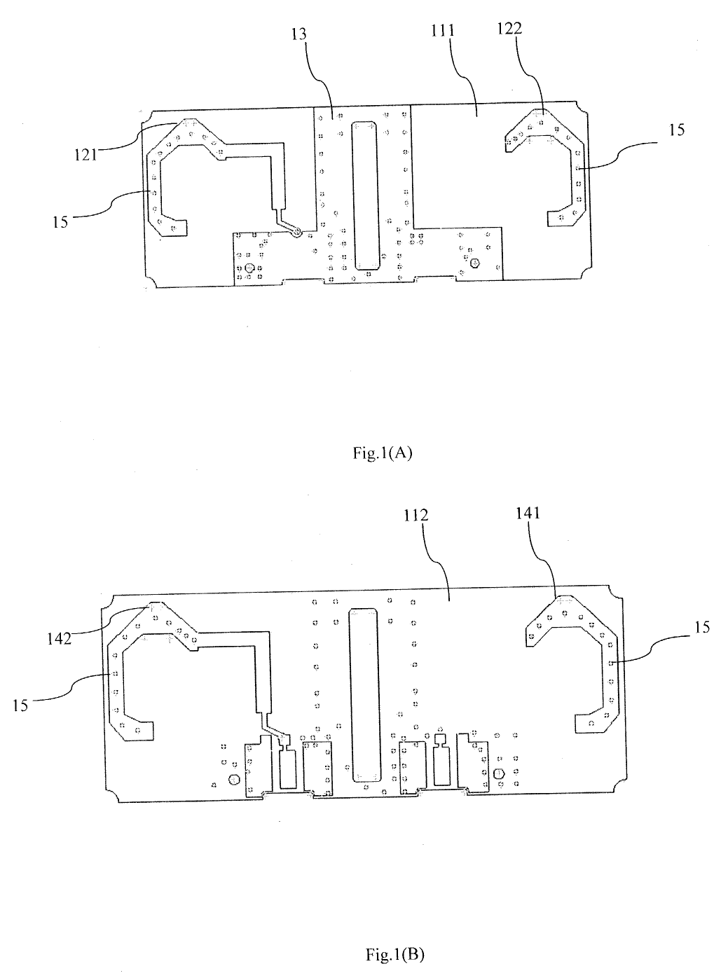

FIGS. 2 (A) (B): The front and back diagrams of the new type circuit board antenna according to the present invention.

The key components of the diagrams are listed as below:

111: Front Surface of the Circuit Board

13: Grounding Part

141, 142: Strip Conducting Part

211, 212: Surface of the Circuit Board

261: The First U-type Conducting Part

231, 232: The Grounding Part

241, 242: The Third Strip Conducting Part

121, 122: Strip Conducting Part

112: Back Surface of the Circuit Board

15: Conducting Via hole

222, 221: Strip Conducting Part

262: The Second U-type Conducting Part

27: The Second Strip Conducting Part

### DETAILED DESCRIPTION OF THE PREFERRED EMBODIMENT

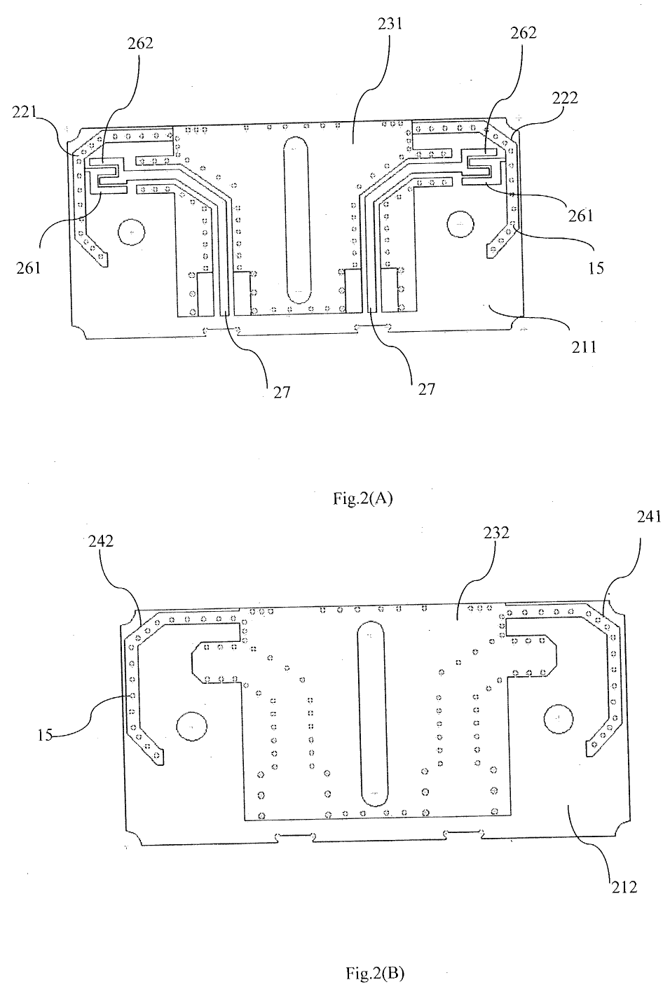

FIGS. 2 (A) (B) are the front and back diagrams of the new type circuit board antenna according to the present invention.

There are two surfaces 211 and 212 on the circuit board. We may find the first strip conducting part 222, the first U-type conducting part 261, the second U-type conducting part 262, the grounding part 231, and the second strip conducting part 27 in the surface 211. On this surface, the first U-type conducting part 261 connects with the first strip conducting part 222, and the second U-type conducting part 262 is complementary with the first U-type conducting part 261. Grounding part 23 connects with the first strip conducting part 222, the second strip conducting part 27 connects with the second U-type conducting part 262 and combines with the grounding part 23 as a micro strip for conducting the antenna signal.

Another surface of the circuit board 212 comprises a third strip conducting part 241. The third strip conducting part 241 (or 242) is parallel with the first strip conducting part 221 (or 222) and intercommunicates by multiple conducting via holes 15. Of course, the surface of another circuit board side 212 comprises another grounding part 232, and these two grounding part 231, 232 also intercommunicate by multiple conducting via holes 15.

Furthermore, the first U-type conducting part 261 and the second U-type conducting part 262 will combine as an r(Gama) matching. The new type circuit board antenna of the present invention can be used in a wireless LAN card. Anyway, the quality of the antenna will be improved by the r(Gama) match of the present invention.

While the invention has been described in terms of what are presently considered to be the most practical and preferred embodiments, it is to be understood that the invention need not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A new type circuit board antenna comprises:
a circuit board having a surface;
a first strip conducting part locating at said surface of said circuit board;
a first U-type conducting part locating at said surface of said circuit board and connecting with said first strip conducting part;
a second U-type conducting part locating at said surface of said circuit board and being complementary with said first U-type conducting part;
a grounding part locating at said surface of said circuit board and connecting with said first strip conducting part; and
a second strip conducting part locating at said surface of said circuit board, connecting with said second U-type conducting part, and combining with said grounding part as a micro strip for conducting an antenna signal.

2. A new type circuit board antenna according to claim 1, wherein a back side of said circuit board surface comprises a third strip conducting part, and said third strip conducting part is parallel with said first strip conducting part and intercommunicates by a plurality of conducting via holes.

3. A new type circuit board antenna according to claim 1, wherein a back side of said circuit board surface comprises another grounding part, and said two grounding parts intercommunicate by a plurality of conducting via holes.

4. A new type circuit board antenna according to claim 1, wherein said first U-type conducting part and said second U-type conducting part are integrated as a r(Gama) matching.

5. A new type circuit board antenna according to claim 1, wherein said new type circuit board antenna is applied to a wireless LAN card.
